(19) United States
(12) Patent Application Publication
(10) Pub. No.: US 2002/0066870 A1
(43) Pub. Date: Jun. 6, 2002

(54) Mask for electron beam projection lithography and method of fabricating the same

(76) Inventor: Fumihiro Koba, Tokyo (JP)

Correspondence Address: McGinn & Gibb, PLLC, Suite 200, 8321 Old Courthouse Road, Vienna, VA, 22182-3817, US

(21) Appl. No.: 09/996,733

(22) Filed: Nov. 30, 2001

(30) Foreign Application Priority Data
Dec. 1, 2000 (JP) 2000-366649

(51) Int. Cl. G21K 5/10

(52) U.S. Cl. 250/492.1

(57) ABSTRACT

In an electron beam projection lithography mask comprising a first silicon substrate (23) on which a transfer pattern is formed and a second silicon substrate (21) of a pillar side which is stuck on the first silicon substrate (23), slits (25) are formed in the first silicon substrate (23) positioned on pillar areas (21a) of the second silicon substrate (21).

### BACKGROUND OF THE INVENTION

1. Field of the Invention

The present invention relates to a mask for electron beam projection lithography and a method of fabricating the mask, and particularly to a mask for electron beam projection lithography and a method of fabricating the mask, in which the position accuracy of a pattern is improved.

2. Description of the Prior Art

FIG. 4 shows a sectional view of a conventional stencil mask.

In the fabricating method of this stencil mask, first, a silicon oxide film 42 having a thickness of approximately 1 μm is formed by thermal oxidation or CVD (Chemical Vapor Deposition) on the surface of a silicon wafer (pillar side silicon substrate) 41 having a diameter of 200 mm. Then, a pattern formation side silicon substrate 43 is stuck and polished to a thickness of about 2 μm by CMP (Chemical Mechanical Polishing) to give a thin film.

A resist is then rotationally applied on the pattern formation side silicon substrate 43 so that a resist pattern is formed employing an electron beam lithography technique.

Using this resist as a mask, silicon of resist aperture portions is etched by a dry etching technique, and patterning the pattern formation side silicon substrate 43 is performed so as to form a transfer pattern 44. Finally, a mask having openings provided in predetermined portions on the back side of the pillar side silicon substrate 41 is formed, and a silicon wet etching (back etch) is performed. That is, back etch is performed until the silicon oxide film 42 is exposed using the silicon oxide film 42 as an etching stopper, and then back etch of the silicon oxide film 42 is performed until the pattern formation side silicon substrate 43 is exposed using the pattern formation side silicon substrate 43 as an etching stopper to form a stencil mask.

In the stencil mask for the electron beam projection lithography described above, a high transfer accuracy is required.

However, since one bulk transfer area and a bulk transfer area adjacent thereto are not separated/independent in conventional stencil mask fabricating methods, that is, since all bulk transfer areas are continuous extending over the whole surface of the wafer, the wafer warps so as to release the stress generated at the time of fabricating the mask and of irradiation of electron beam. As a result, there is a shortcoming that the pattern position accuracy deteriorates.

FIG. 5 shows a sectional view of a conventional membrane mask.

In a fabricating method of the membrane mask, first, a silicon nitride film 52 having a thickness of about 1500 Å is formed on the surface of a silicon wafer (pillar side silicon substrate) 51 having a diameter of 200 mm by CVD (Chemical Vapor Deposition). This silicon nitride film 52 plays a role as an electron permeating body.

Then, a metal film 53 such as tungsten, chromium and the like having a thickness of about 200 Å is formed on the silicon nitride film 52 by a spattering method or a CVD method. This metal film 52 plays a role as an electron dispersing body.

A resist is rotationally applied to the metal film 53 to form a resist pattern using an electron beam lithography technique. Using this resist as a mask, the metal film 53 of resist aperture portions is etched by a dry etching technique to form a transfer pattern 53.

Finally, a mask having openings provided in predetermined portions on the back side of the pillar side silicon substrate 51 is formed, and a silicon wet etching (back etch) is performed. That is, back etch is performed until the silicon nitride film 52 is exposed using the silicon nitride film 52 as an etching stopper to form a membrane mask.

In the membrane mask for the electron beam projection lithography described above also, a high transfer accuracy is required similarly to the stencil mask.

However, since one bulk transfer area and a bulk transfer area adjacent thereto are not separated/independent in conventional membrane mask described above, that is, since the membrane film (silicon nitride film) is continuous extending over the whole surface of the wafer on all bulk transfer areas, with this structure, the wafer warps so as to release the stress generated at the time of fabricating the mask and of irradiation of electron beam. As a result, there is a shortcoming that the pattern position accuracy deteriorates.

For example, Japanese Unexamined Patent Publication No. 5-234858 discloses a technology that in order to compensate the stress of an X-ray absorbing layer by the physical property of a membrane supporting the X-ray absorbing layer, grooves are formed in the back face and the surface of the membrane to regulate the stress so as to improve the pattern position accuracy. This technology tentatively produces an effect in terms of the pattern position accuracy improvement in one bulk transfer area.

However, in the invention, the membrane film is continuous over the whole surface of the wafer, that is, over all bulk transfer areas, and any solution for the warp over the whole surface of the wafer is not shown.

### SUMMARY OF THE INVENTION

An object of the present invention is to provide a new mask for electron beam projection lithography and a method of fabricating the mask, in which the shortcoming in the prior art described above is improved, a warp is prevented specifically by releasing the stress generated at the time of fabricating the mask and of irradiation of electron beam, and thus the position accuracy of the transfer pattern is improved.

In order to achieve the object described above, the present invention basically adopts a technical structure as described below.

That is, a first aspect of the present invention is a mask for electron beam projection lithography comprising a first silicon substrate on which a transfer pattern is formed and a second silicon substrate of a pillar side that is stuck on the first silicon substrate, wherein a slit is formed in the first silicon substrate positioned on a pillar area of the second silicon substrate.

In the second aspect of the present invention, the slit is provided so as to surround the transfer pattern.

In the third aspect of the present invention, the slit is formed so as to penetrate through the first silicon substrate.

The fourth aspect of the present invention is a mask for electron beam projection lithography comprising a membrane on which a transfer pattern by a metal film is formed and a pillar side silicon substrate supporting the membrane, wherein a slit is formed in the membrane positioned on a pillar area of the pillar side silicon substrate.

The fifth aspect of the present invention is a fabricating method of a mask for electron beam projection lithography comprising a first silicon substrate on which a transfer pattern is formed and a second silicon substrate of a pillar side which is stuck on the first silicon substrate, wherein the method comprising the step of: forming a slit in the first silicon substrate positioned on a pillar area of the second silicon substrate, and the transfer pattern in the first silicon substrate, simultaneously.

The sixth aspect of the present invention is a fabricating method of a mask for electron beam projection lithography comprising a membrane on which a transfer pattern by a metal film is formed and a pillar side silicon substrate supporting the membrane, wherein the method comprising the step of: forming a slit in the membrane positioned on a pillar area of the pillar side silicon substrate, and forming the transfer pattern on the membrane.

### BRIEF DESCRIPTION OF THE DRAWINGS

FIG. 1 is a plan view of a wafer.

FIG. 2(a) is a sectional view of a stencil mask of a first specific example of the present invention.

FIG. 2(b) is a plan view of a stencil mask shown in FIG. 1(a).

FIG. 4 is a sectional view of a conventional stencil mask.

FIG. 5 is a sectional view of a conventional membrane mask.

### DETAILED DESCRIPTION OF THE PREFERRED EMBODIMENTS

The present invention relates to a transfer mask employed for electron beam projection lithography and is characterized in that a stress release opening is provided in part of a mask positioned in a pillar area.

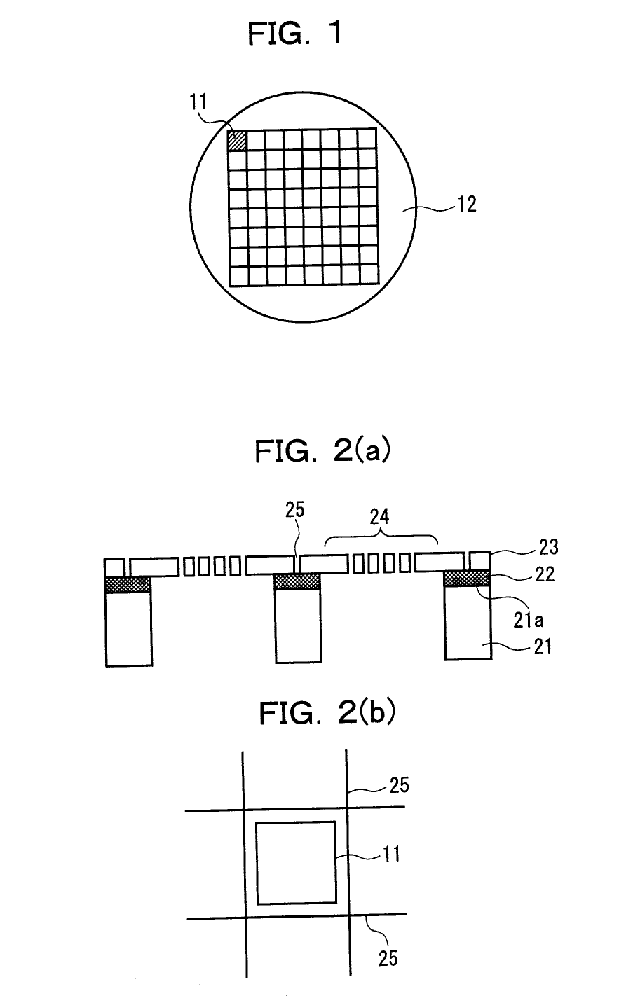

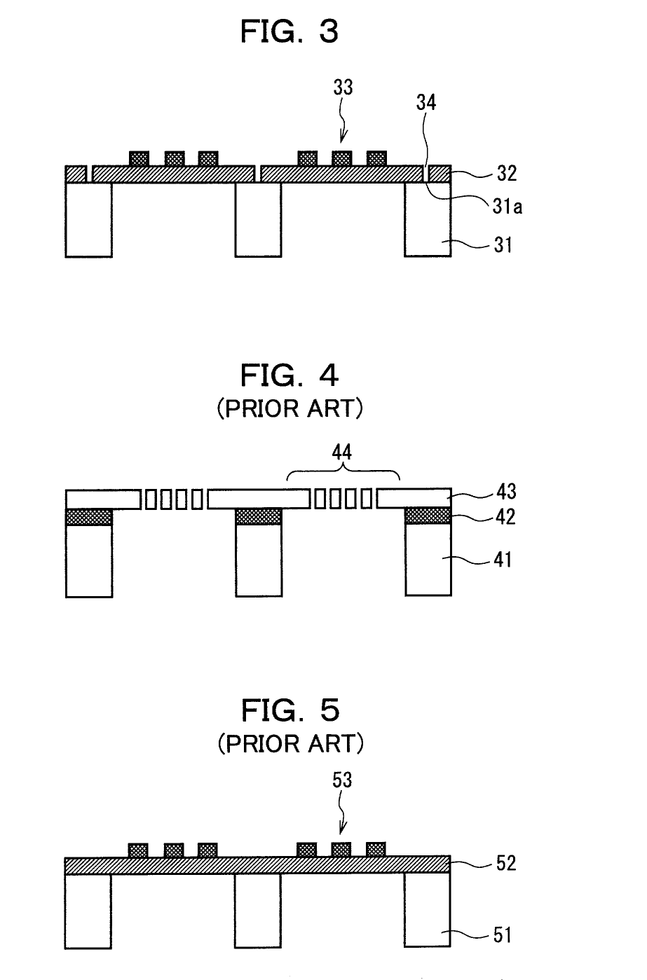

FIG. 1 shows an example of a mask for electron beam projection lithography. A bulk transfer area 11 of 1 mm² is arranged in a matrix manner on a wafer 12 having a diameter of 200 mm .

FIG. 2(a) shows a sectional view of a stencil mask for electron beam projection lithography according to the present invention, and FIG. 2(b) shows a plan view thereof.

The stencil mask is fabricated generally using a stuck SOI wafer and has a structure in which a silicon oxide film 22 is sandwiched by a pillar side silicon substrate 21 and a pattern formation side silicon substrate 23, and a transfer pattern 24 is formed on the pattern formation side silicon substrate 23 by a dry etching technique.

In the stencil mask of such structure, the present invention is characterized in that stress release openings 25 composed of slits are provided in the pattern formation side silicon substrate 23 of areas to be pillars of the stencil mask.

By providing the stress release openings 25, one bulk separated/independent, and the stress generated at the time of fabricating the mask is released, whereby the improvement of flatness over the whole surface of the wafer, that is, the improvement of the pattern position accuracy becomes possible. Specifically, the warp generation amount of the wafer due to the stress generated at the time of back etch from the back face of the stencil mask can be restrained.

The stress release openings 25 can release the stress due to the difference in the coefficients of thermal expansion of the silicon oxide film 22 and the pattern formation side silicon substrate 23 with heating during the time electron beam is irradiated, whereby the pattern position accuracy during electron beam drawing can be improved.

Specific mask examples for electron beam projection lithography and a method of fabricating the mask according to the present invention are explained in detail referring to drawings below.

(First Specific Example)

FIG. 2(a) is a sectional view illustrating the structure of the first specific example of a mask for electron beam projection lithography according to the present invention, and FIG. 2(b) is a plan view thereof. In the electron beam projection lithography mask comprising the first silicon substrate 23 on which the transfer pattern 24 is formed and the second silicon substrate 21 of the pillar side which is stuck on the first silicon substrate 23, shown in FIGS. 2(a) and 2(b), the electron beam projection lithography mask characterized in that slits 25 are formed in the first silicon substrate 23 positioned on pillar areas 21a of the second silicon substrate 21, is shown.

The electron beam projection lithography mask characterized in that the slits 25 are provided so as to surround the transfer pattern 24, is shown, and further the electron beam projection lithography mask characterized in that the slits 25 are formed by penetrating the first silicon substrate 23, is shown.

The first specific example is explained in further detail employing FIG. 2 below.

In the present stencil mask, the silicon oxide film 22 having a thickness of about 1 μm is first formed on the surface of the silicon wafer (pillar side silicon substrate) 21 having a diameter of 200 mm by a thermal oxidation method or CVD (Chemical Vapor Deposition) as shown in FIG. 2. Then, the pattern formation side silicon substrate 23 is stuck on the silicon wafer 21 and is polished to a thickness of about 2 μm by a CMP (Chemical Mechanical Polishing) technique to make a thin film.

A resist is then rotationally applied on the pattern formation side silicon substrate 23 so that a resist pattern is formed employing an electron beam lithography technique. At this time, at the same time, a pattern for forming the stress release openings 25 is formed in the areas 21a to be pillars of the stencil mask. Using this resist as a mask, silicon on resist aperture portions is etched by a dry etching technique, and patterning the pattern formation side silicon substrate 23 is performed so as to form the transfer pattern 24 and the stress release opening 25 that is a slit. The transfer pattern 24 and the stress release opening 25 are formed by penetrating the pattern formation side silicon substrate 23.

Finally, the mask having openings provided in predetermined portions on the rear face side of the pillar side silicon substrate 21 is formed, and a silicon wet etching (back etch) is performed. That is, back etch of the silicon wafer 21 is performed until the silicon oxide film 22 is exposed using the silicon oxide film 22 as an etching stopper, and then back etch of the silicon oxide film 22 is performed until the pattern formation side silicon substrate 23 is exposed using the pattern formation side silicon substrate 23 as an etching stopper to form a stencil mask.

Since the stress release opening 25 is formed in the pillar area 21a, transfer is not given on the wafer 12.

(Second Specific Example)

FIG. 3 is a sectional view illustrating the second specific example of a mask for electron beam projection lithography according to the present invention. In the electron beam projection lithography mask comprising a membrane 32 on which a transfer pattern by a metal film 33 is formed and a pillar side silicon substrate 31 supporting the membrane 32, shown on FIG. 3, the electron beam projection lithography mask characterized in that slits 34 are formed in the membrane 32 positioned on pillar areas 31a of the pillar side silicon substrate 31.

In this specific example as well, the slits 34 are formed by penetrating the membrane 32, and the slits 34 are provided so as to surround the transfer pattern.

The second specific example is explained further in detail below.

FIG. 3 is the sectional view of the membrane mask of the second specific example of the present invention.

In the present membrane mask, the silicon nitride film 32 having a thickness of about 150 Å is formed on the surface of the silicon wafer (pillar side silicon substrate) 31 having a diameter of 200 mm by CVD (Chemical Vapor Deposition) as shown in FIG. 3. The silicon nitride film 32 plays a role as an electron permeating body (membrane).

A resist is then rotationally applied on the silicon nitride film 32 so that a resist pattern for forming the stress release openings 34 is formed employing an electron beam lithography technique. Using this resist as a mask, the silicon nitride film 32 of resist aperture portions is etched by a dry etching technique to form the stress release openings 34.

Then, the metal film 33 such as tungsten, chromium and the like having a thickness of about 200 Å is formed on the silicon nitride film 32 by a spattering method or a CVD method. This metal film 33 plays a role as an electron dispersing body.

A resist is rotationally applied to the metal film 33 to form a resist pattern using an electron beam lithography technique. Using this resist as a mask, the metal film 33 of resist aperture portions is etched by a dry etching technique to form the transfer pattern 33.

Finally, a mask having openings provided in predetermined portions on the back face side of the pillar side silicon substrate 31 is formed, and a silicon wet etching (back etch) is performed. That is, back etch of the pillar side silicon substrate 31 is performed until the silicon nitride film 32 is exposed using the silicon nitride film 32 as an etching stopper to form the membrane mask shown in FIG. 3.

In the first and second specific examples described above, although a transfer pattern is first formed and then back etch is performed from the back face of the pillar side silicon substrate, effects of the present invention can be achieved even through back etch of the pillar side silicon substrate is first performed and then a transfer pattern is formed.

Although the present invention is applied to a mask for electron beam lithography in the explanation above, effects of the present invention can be obtained even when it is applied to a mask for X-ray lithography or a mask for ion-beam lithography.

According to the present invention, a slit releases the stress generated at the time of fabricating a mask and of irradiation of electron beam to prevent a warp and, as a result, the position accuracy of the transfer pattern can be improved.

What is claimed is:

1. A mask for electron beam projection lithography comprising a first silicon substrate on which a transfer pattern is formed and a second silicon substrate of a pillar side that is stuck on said first silicon substrate, wherein a slit is formed in said first silicon substrate positioned on a pillar area of said second silicon substrate.

2. The mask for electron beam projection lithography according to claim 1, wherein said slit is provided so as to surround said transfer pattern.

3. The mask for electron beam projection lithography according to claim 1, wherein said slit is formed so as to penetrate through said first silicon substrate.

4. A mask for electron beam projection lithography comprising a membrane on which a transfer pattern by a metal film is formed and a pillar side silicon substrate supporting said membrane, wherein a slit is formed in said membrane positioned on a pillar area of said pillar side silicon substrate.

5. The mask for electron beam projection lithography according to claim 4, wherein said slit is provided so as to surround said transfer pattern.

6. The mask for electron beam projection lithography according to claim 4, wherein said slit is formed so as to penetrate through said membrane.

7. A fabricating method of a mask for electron beam projection lithography comprising a first silicon substrate on which a transfer pattern is formed and a second silicon substrate of a pillar side which is stuck on said first silicon substrate, wherein said method comprising the step of:
forming a slit in said first silicon substrate positioned on a pillar area of said second silicon substrate, and said transfer pattern in said first silicon substrate, simultaneously.

8. The fabricating method according to claim 7, wherein said slit is formed so as to surround said transfer pattern.

9. A fabricating method of a mask for electron beam projection lithography comprising a membrane on which a transfer pattern by a metal film is formed and a pillar side silicon substrate supporting said membrane, wherein said method comprising the step of:
forming a slit in said membrane positioned on a pillar area of said pillar side silicon substrate, and
forming said transfer pattern on said membrane.

10. The fabricating method according to claim 9, wherein said slit is provided so as to surround said transfer pattern.
